(19) United States
(12) Patent Application Publication
(10) Pub. No.: US 2026/0368021 A1
(43) Pub. Date: Nov. 19, 2026

(54) PREVENTIVE MAINTENANCE METHOD FOR A COMPUTER PERIPHERAL DEVICE

(71) Applicant: BANKS AND ACQUIRERS INTERNATIONAL HOLDING, SURESNES (FR)

(72) Inventor: Laurent REIFFSTECK, VALENCE (FR)

(21) Appl. No.: 19/126,337

(22) PCT Filed: Nov. 3, 2023
(86) PCT No.: PCT/EP2023/080740

§ 371 Date: Jun. 5, 2025

(30) Foreign Application Priority Data
Nov. 3, 2022 (FR) FR2211465

(51) Int. Cl. G06F 11/07

(52) U.S. Cl. CPC G06F 11/079; G06F 11/0793

(57) ABSTRACT

A method for detecting the risk of malfunction of a computer peripheral device, wherein a computer performs the steps of obtaining data relating to a current state of a computer peripheral device and filtering the obtained data in such a way as to retain only some of these data, the retained data forming filtered data. The computer further performs the steps of applying a negative-selection artificial immune algorithm to the filtered data, so as to distinguish data forming a fault profile from data forming a normal operating profile, and applying a random forest algorithm to the data forming the fault profile, so as to detect one or more components at risk of malfunction within the computer peripheral device.

### FIELD OF THE INVENTION

The invention relates to the field of maintenance of computer peripheral devices. It relates in particular to the maintenance of payment terminals.

### BACKGROUND

The operation of a payment terminal on the premises of a professional, such as a merchant, is sometimes interrupted due to malfunctions of the terminal. It is then necessary to perform a maintenance operation on the terminal, either manually by sending an operator on site, or remotely by using a payment terminal management server to transmit software modifications to the terminal. However, these corrective maintenance operations are expensive and the downtime of the terminal is inconvenient for the users.

A predictive maintenance method aimed at anticipating a malfunction of a terminal is already known in the state of the art. It consists in alerting the server, and possibly an operator, as soon as a predetermined threshold, corresponding in particular to a number of operation cycles of the terminal, is reached. Thus, the alert sent provides a means, by sending an operator or via the server, of performing a maintenance operation aimed at preventing a malfunction, to avoid possible downtime of the terminal.

However, the alert thresholds set are arbitrary, limited to some parameters, independent of each other, generalised to all the terminals, so alerts are raised for terminals which could however continue to operate normally, when other alerts are not raised for terminals which finally break down. In addition, due to the high number of variables and parameters of the terminals, it is difficult to set relevant thresholds beforehand to prevent a malfunction in time and appropriately. Maintenance of a terminal is therefore sometimes unnecessary, sometimes insufficient, and thus always expensive and inconvenient.

### SUMMARY

The invention aims in particular to optimise the maintenance of computer peripheral devices. It also aims to manage to anticipate a malfunction optimally despite a large number of data to be processed.

The invention therefore relates to a method for detecting the risk of malfunction of a computer peripheral device, wherein computing means perform the steps of:
obtaining data relating to a current state of a computer peripheral device;
filtering the obtained data in such a way as to retain only some of these data, the retained data forming filtered data;
applying a negative-selection artificial immune algorithm to the filtered data so as to distinguish data forming a fault profile from data forming a normal operating profile;
applying a random forest algorithm to the data forming the fault profile so as to detect one or more components at risk of malfunction within the computer peripheral device.

Thus, the filtering is used to sort the large number of data received in such a way as to only retain some of these data to be processed in order to identify in the next steps a possible future malfunction of a peripheral device. By reducing, via the filtering, the number of data to be processed by the negative-selection and random forest algorithms, the method becomes fast and capable of being integrated on an autonomous device, such as a payment terminal management server.

The negative-selection immune algorithm is used to identify, amongst the filtered data, those which form data associated with a peripheral device in normal operating state, to reject them. Thus, only the data associated with a peripheral device which is not in normal operating state, or which is at risk of not being in normal operating state soon, are transmitted to the next step. Lastly, using the data associated with a real or future malfunction of a peripheral device, the random forest (or random decision forest) algorithm can be used to identify the components of the peripheral device responsible for this malfunction.

Thus, the method can be used to process all the data from the peripheral device to identify whether it is at risk and, where applicable, which of its components are responsible for the risk of malfunction. The invention therefore allows preventive and optimised maintenance, raising alerts only in appropriate cases, to avoid any unnecessary maintenance operation. The invention can also be used to process a large number of data quickly.

Advantageously, the computing means perform the steps of:
identifying, during the step of applying the immune algorithm, data types to distinguish between the fault profile and the normal operating profile;
identifying, during the step of applying the random forest algorithm, data types allowing the detection of the one or more faulty characteristics;
the data types identified during the two identification steps forming data types to be filtered, integrating in the filtering step data types to be filtered, so that, when reiterating the method, the filtering step is performed on the basis of the data types to be filtered.

Thus, the method includes a self-regulation loop. This loop aims to identify the data to be filtered during the filtering step on the basis of the next steps.

Thus, in one embodiment, on each iteration of the method, data types are identified at the output of the negative-selection immune algorithm, those used to identify a peripheral device having a real or future malfunction. In particular, the parameters, in other words the names of the variables of the peripheral device to which these data refer, can be identified as types corresponding to data to be processed during the next iteration. Similarly, at the output of the random forest algorithm step, the data used to identify components at risk of the peripheral device are selected as being part of the data types to be filtered. Consequently, when the method is executed again, during the filtering step, the computing means retain the data from the peripheral device which are associated with the filtered data types, in particular the data associated with the parameters deemed important to be considered during the previous iterations. The other data are not processed by the next steps.

In an alternative embodiment, rather than retaining some data types to be processed in the next iterations, the computing means do the opposite: they identify the data types which must not be considered during the filtering, those which have not proved to be useful, so that only the relevant data are processed during the next iteration.

In short, in the two embodiments and in any combination of these embodiments, the computing means identify, at the output of the immune algorithm and at the output of the random forest algorithm, data types to be filtered during the filtering step for the next iterations of the method. This self-regulation constantly improves the precision of the method, while reducing the number of data to be processed.

Preferably, beforehand, since the data types to be filtered do not exist, the computing means perform, on a learning database, a step of training relating to the filtering, in order to identify first data types to be filtered.

Thus, the computing means are trained to identify first data types to be filtered so that the negative-selection and random forest algorithms do not have to process too many data during the first iterations of the method.

Advantageously, beforehand, the computing means perform, on a learning database, a step of training the negative-selection artificial immune algorithm, in order to form computer peripheral device fault profile detectors.

Thus, the negative-selection algorithm is trained, beforehand, so that it can create relevant fault profile detectors before applying these detectors to peripheral device data under real conditions.

Preferably, an affinity distance relating to the fault profile detectors is a Jaro-Winkler distance.

Advantageously, beforehand, the computing means perform, on a learning database, a step of training the random forest algorithm, in order to learn how to detect faulty characteristics of computer peripheral devices.

Thus, the random forest algorithm is trained beforehand to identify the components responsible for a real or future malfunction of a peripheral device, before applying this algorithm to the data of peripheral devices under real conditions.

Preferably, the peripheral device is a payment terminal.

Thus, the computing means obtain data from the terminal, relating to all the parameters of the terminal, in order to deduce whether this terminal is at risk of malfunctioning soon, and, where applicable, which components are responsible for this risk. The means can then be used to perform preventive maintenance on the terminal. Advantageously, the obtained data of the payment terminal relate to:
a counter of keys pressed on the terminal;
a number of times the terminal operating system has been reloaded;
a number of times the terminal has been restarted;
a version number of the terminal software;
an Internet connection type of the terminal;
an Internet connection state of the terminal;
a connection type of the terminal;
a connection state of the terminal;
a manufacturer code of the terminal;
a type of computer hardware integrated in the terminal.

The invention also provides for a maintenance method for a computer peripheral device, wherein computing means perform the steps of:
implementing the method for detecting the risk of malfunction of a computer peripheral device, as described previously;
depending on the malfunction detected, identifying a correction to be made to a software configuration of the peripheral device.

Thus, the means identify an action to be performed, for example a change of software configuration, to prevent a malfunction of the terminal. The identified action results directly from the method for identifying a risk of malfunction, it is related to the components identified.

Preferably, the computing means further perform a step of automatically correcting the peripheral device by applying the identified correction to the peripheral device.

Thus, the identified correction is made automatically, with no need for a manual intervention.

The invention also provides for a maintenance server comprising computing means adapted to perform the steps of the methods described previously.

The invention also provides for a payment system comprising a maintenance server as described above and at least one payment terminal, the payment terminal being adapted to transmit to the server data relating to a current state of the terminal.

The invention also provides for a computer program comprising instructions which, when the program is executed by a computer, instruct the computer to perform the steps of the methods described previously.

The invention also provides for a computer-readable storage medium comprising instructions which, when they are executed by a computer, instruct the computer to perform the steps of the methods described previously.

### BRIEF DESCRIPTION OF THE DRAWINGS

The invention will be better understood on reading the following description, given solely by way of example and with reference to the accompanying drawings in which:

FIG. 1 is a diagram of a system comprising a server according to one embodiment of the invention;

FIG. 2 is a diagram of an autonomous module of the server of FIG. 1;

FIG. 3 is a flowchart of a method for identifying a risk of malfunction of the peripheral device according to one embodiment of the invention;

FIG. 4 is a flowchart of a maintenance method according to one embodiment of the invention;

FIG. 5 is a flowchart of an initialisation method according to one embodiment of the invention.

### DETAILED DESCRIPTION

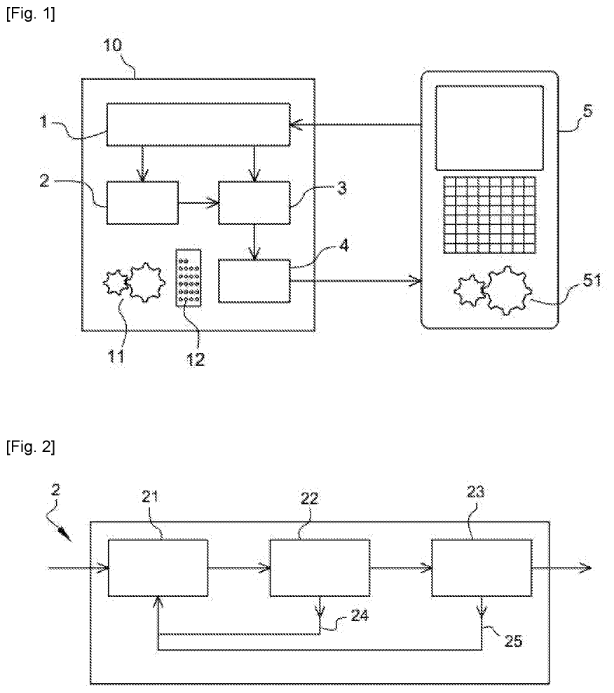

FIG. 1 is a diagrammatic view of a payment terminal management server 10 and a payment terminal 5.

The server 10 comprises conventional computing means 11, including a read-only memory, a random-access memory, a processor. This server 10 also comprises, in executable and stored form, a computer program 12 implementing, when it is executed by the means 11, the methods 100 to 300 described below.

The software of this server is divided between a supervision module 1, an autonomous module 2, a scheduling module 3 and an assignment module 4. These modules use the same computing means 11 and the same computer program 12. Alternatively, separate computer programs operating on the same server 10 could be used. Alternatively again, separate programs operating on separate devices with their own computing means could be used. These arrangements do not affect in any way the methods described below.

The supervision module 11 receives information from the payment terminals to be supervised, in particular from the terminal 5. This information comprises all the data sent by the terminal 5, relating to the current state of the terminal 5, some of which will be mentioned below. The autonomous module 2 executes the method 100 for identifying the risk of malfunction of the terminal 5 described below. It receives from the supervision module 1 the data of the terminal 5, and therefore determines whether the terminal 5 is at risk of malfunction, where applicable which of its components are responsible for the risk of malfunction. The scheduling module 3, using data received from the supervision module 1 and the autonomous module 2, decides on possible actions to be considered for the terminal 5, if the latter has a risk of malfunction. The assignment module 4 transmits the actions decided, in particular the configuration changes decided, to the payment terminal 5.

The payment terminal 5 is a conventional payment terminal, comprising conventional computing means 51 configured to operate the terminal. These means 51 are adapted to regularly transmit the data from the terminal 5 to the server 10, and in particular to its supervision module 1. They are also adapted to receive software modification instructions from the assignment module 4.

We will now describe the autonomous module 2, referring to FIG. 2. Its software can be divided into three sub-modules: a filtering sub-module 21, an optimisation sub-module 22, and a decision sub-module 23. The data of the terminal 5, supplied by the supervision module 1, circulate from the sub-module 21 to the output of the sub-module 23, the output data then being transmitted to the scheduling module 3. However, the autonomous module 2 also contains a self-regulation loop, shown by the arrows 24 and 25, between the sub-modules 21, 22 and 23. Thus, as described below, the optimisation sub-module 22 is adapted to identify, during the data processing, data types to be filtered. The decision sub-module 23 is adapted to do the same, all these data types to be filtered being transmitted to the module 21, by the returns 24 and 25 to continuously improve the filtering.

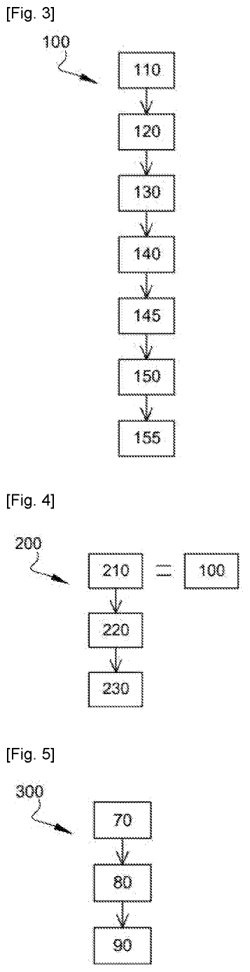

We will now describe, referring to FIGS. 2 and 3, a method 100 for detecting the risk of malfunction in the terminal 5.

In step 110, the terminal 5 sends, using its means 51, data relating to the state of the terminal to the supervision module 1 of the server 10.

In step 120, the supervision module 1 transmits these data to the autonomous module 2, more specifically to the filtering sub-module 21. The following table contains an extract of all the data obtained by this filtering sub-module for several payment terminals.

TABLE 1

| | | | | | | | | | | |
|---|---|---|---|---|---|---|---|---|---|---|
| NETWORK PORT NUMBER | NULL | NULL | NULL | NULL | NULL | NULL | NULL | NULL | NULL | NULL |
| NETWORK PREFIX | NULL | NULL | NULL | NULL | NULL | NULL | NULL | NULL | NULL | NULL |
| NETWORK SERIAL LINK | NULL | NULL | NULL | NULL | NULL | NULL | NULL | NULL | NULL | NULL |
| NETWORK_SSL_ACTIVATED | NULL | NULL | NULL | NULL | NULL | NULL | NULL | NULL | NULL | NULL |
| NETWORK SSL NAME | NULL | NULL | NULL | NULL | NULL | NULL | NULL | NULL | NULL | NULL |
| OPTION CARD | NULL | NULL | NULL | NULL | NULL | NULL | NULL | NULL | NULL | NULL |
| OPTION CARD TYPE | 0 | NULL | 0 | 0 | 0 | NULL | 0 | NULL | NULL | 0 |
| OS COUNTER 20 | 10607949 | 17413202 | 31438162 | 697134 | 3340348 | 5809118 | 20616968 | 48098275 | 37219672 | 35161389 |
| OS_COUNTER_21 | NULL | NULL | NULL | NULL | 12 | 1 | NULL | 510 | 359 | 4391 |
| OS COUNTER 22 | 235321 | 338219 | 149013 | 4863 | 53383 | 129851 | 217776 | 356111 | 672721 | 203062 |
| OS COUNTER 23 | NULL | NULL | NULL | NULL | NULL | NULL | NULL | NULL | NULL | NULL |
| OS COUNTER 24 | NULL | NULL | NULL | NULL | NULL | NULL | NULL | NULL | NULL | NULL |
| OS COUNTER 25 | NULL | NULL | NULL | NULL | NULL | NULL | NULL | NULL | NULL | NULL |
| OS_COUNTER_26 | NULL | NULL | NULL | NULL | NULL | NULL | NULL | NULL | NULL | NULL |
| OS COUNTER 27 | NULL | NULL | NULL | NULL | NULL | NULL | NULL | NULL | NULL | NULL |
| OS COUNTER 28 | NULL | NULL | NULL | NULL | NULL | NULL | NULL | NULL | NULL | NULL |
| OS COUNTER 29 | NULL | NULL | NULL | NULL | NULL | NULL | NULL | NULL | NULL | NULL |
| OS COUNTER 30 | NULL | NULL | NULL | NULL | NULL | NULL | NULL | NULL | NULL | NULL |
| OS_COUNTER_31 | NULL | NULL | NULL | NULL | NULL | NULL | NULL | NULL | NULL | NULL |
| PABX | NULL | NULL | NULL | NULL | NULL | NULL | NULL | NULL | NULL | NULL |
| PHONE HOME STATUS | NULL | NULL | NULL | NULL | NULL | NULL | NULL | NULL | NULL | NULL |
| PID | NULL | NULL | NULL | NULL | NULL | NULL | NULL | NULL | NULL | NULL |
| PINPAD ACTIVATED | NULL | NULL | NULL | NULL | NULL | NULL | NULL | NULL | NULL | NULL |
| PINPAD_CONNECTED | NULL | NULL | NULL | NULL | NULL | NULL | NULL | NULL | NULL | NULL |
| PINPAD PKI LEVEL | NULL | NULL | NULL | NULL | NULL | NULL | NULL | NULL | NULL | NULL |
| PINPAD TYPE | 1 | 1 | 1 | 1 | 1 | 1 | 1 | 1 | 1 | 1 |
| PKI | 3 | 3 | 3 | 3 | 3 | 3 | 3 | 3 | 3 | 3 |
| PLATFORM | 1 | 1 | 0 | 1 | 1 | 1 | 1 | 0 | 1 | 1 |
| POE_TYPE | NULL | NULL | NULL | NULL | NULL | NULL | NULL | NULL | NULL | NULL |
| PORTABLE | 1 | 1 | NULL | 1 | 1 | 1 | 1 | NULL | 1 | 1 |
| PRINTER | 1 | 1 | 1 | 1 | 1 | 1 | 1 | 1 | 1 | 1 |
| PRINTER TYPE | 2 | 1 | 1 | 1 | 2 | 1 | 1 | 1 | 1 | 1 |
| PRODUCT CODE | M76 | M71 | M74 | M71 | M76 | M71 | M75 | M70 | M71 | M75 |
| PRODUCT_NAME | Move2500 | Move5000 | DESK3500 | Move5000 | Move2500 | Move5000 | Move3500 | DESK5000 | Move5000 | Move3500 |
| PRODUCT REFERENCE | 10174 | 10099 | 10201 | 10185 | 10509 | 10099 | 10181 | 10108 | 10099 | 10186 |
| PRODUCT TYPE | 1 | 1 | 1 | 1 | 1 | 1 | 1 | 1 | 1 | 1 |
| PWR USB TYPE | NULL | NULL | NULL | NULL | NULL | NULL | NULL | NULL | NULL | NULL |
| ROAMING | NULL | NULL | NULL | NULL | NULL | NULL | NULL | NULL | NULL | NULL |
| ROTATION | 3 | NULL | NULL | NULL | 3 | NULL | NULL | NULL | NULL | NULL |
| RTC TYPE | 1 | 1 | 1 | 1 | 1 | 1 | 1 | 1 | 1 | 1 |
| SAM1 | 1 | 1 | 1 | 1 | 1 | 1 | 1 | 1 | 1 | 1 |
| SAM2 | 1 | 1 | 1 | 1 | 1 | 1 | 1 | 1 | 1 | 1 |
| SAM3 | NULL | NULL | NULL | NULL | 1 | NULL | NULL | 1 | NULL | NULL |
| SCHEME_TYPE | 1 | 1 | 1 | 1 | 1 | 1 | 1 | 1 | 1 | 1 |
| SDCARD | NULL | 1 | NULL | 1 | NULL | 1 | 1 | 1 | 1 | 1 |
| SENSOR ACCEL | NULL | 1 | NULL | 1 | NULL | 1 | NULL | NULL | 1 | NULL |
| SERIAL | 1.6183E+23 | 1.71E+23 | 1.63E+23 | 1.71E+23 | 1.72E+23 | 1.71E+23 | 1.63E+23 | 1.52E+23 | 1.61E+23 | 1.63E+23 |
| SERIAL ISLERO | 364d363202 [symbol] | 344d533204 [symbol] | 364d363217 [symbol] | 3336573601 [symbol] | 3.56E+15 | 344d533204 [symbol] | 344d533202 [symbol] | 333850360 [symbol] | 364363215 [symbol] | 344d533206 [symbol] |
| SMC_TYPE | 2 | 1 | 1 | 1 | 2 | 1 | 2 | 1 | 1 | 2 |
| SRED | NULL | NULL | NULL | NULL | NULL | NULL | NULL | NULL | NULL | NULL |
| STRING USB | NULL | NULL | NULL | NULL | NULL | NULL | NULL | NULL | NULL | NULL |
| SUB PLATFORM | 65 | 64 | 3 | 66 | 65 | 64 | 64 | 2 | 64 | 64 |
| SUPPORTED CURRENCIES | NULL | NULL | NULL | NULL | NULL | NULL | NULL | NULL | NULL | NULL |
| SWIPE_ACTIVATED | NULL | NULL | NULL | NULL | NULL | NULL | NULL | NULL | NULL | NULL |
| SWP TYPE | 1 | 1 | 1 | 1 | 1 | 1 | 1 | 1 | 1 | 1 |
| SYS CH TYPE | 2 | 2 | 2 | 2 | 2 | 2 | 2 | 2 | 2 | 2 |
| TCH TYPE | 0 | 4 | 0 | 4 | 0 | 4 | 0 | 1 | 4 | 0 |
| TEL [symbol] UM SDK | NULL | NULL | NULL | NULL | NULL | NULL | NULL | NULL | NULL | NULL |
| TERMINAL_DATE | NULL | NULL | NULL | NULL | NULL | NULL | NULL | NULL | NULL | NULL |
| TERMINAL NUMBER | NULL | NULL | NULL | NULL | NULL | NULL | NULL | NULL | NULL | NULL |
| TERMINAL PCI PTS | NULL | NULL | NULL | NULL | NULL | NULL | NULL | NULL | NULL | NULL |
| TERMINAL PCI PTS M1 | NULL | NULL | NULL | NULL | NULL | NULL | NULL | NULL | NULL | NULL |
| TERMINAL PCI PTS M3 | NULL | NULL | NULL | NULL | NULL | NULL | NULL | NULL | NULL | NULL |
| TERMINAL_PCI_PTS_M4 | NULL | NULL | NULL | NULL | NULL | NULL | NULL | NULL | NULL | NULL |
| TERMINAL PKI LEVEL | NULL | NULL | NULL | NULL | NULL | NULL | NULL | NULL | NULL | NULL |
| TERMINAL TIME | NULL | NULL | NULL | NULL | NULL | NULL | NULL | NULL | NULL | NULL |
| TMS ACCESS TYPE | NULL | NULL | NULL | NULL | NULL | NULL | NULL | NULL | NULL | NULL |
| TMS APN | NULL | NULL | NULL | NULL | NULL | NULL | NULL | NULL | NULL | NULL |
| TMS_CALL_NUMBER | NULL | NULL | NULL | NULL | NULL | NULL | NULL | NULL | NULL | NULL |
| TMS IDENTIFIER | NULL | NULL | NULL | NULL | NULL | NULL | NULL | NULL | NULL | NULL |
| TMS IP ADDRESS | NULL | NULL | NULL | NULL | NULL | NULL | NULL | NULL | NULL | NULL |
| TMS LOGIN | NULL | NULL | NULL | NULL | NULL | NULL | NULL | NULL | NULL | NULL |
| TMS PASSWORD | NULL | NULL | NULL | NULL | NULL | NULL | NULL | NULL | NULL | NULL |
| TMS_PORT_NUMBER | NULL | NULL | NULL | NULL | NULL | NULL | NULL | NULL | NULL | NULL |
| TMS PROTECTION ACTIVATED | NULL | NULL | NULL | NULL | NULL | NULL | NULL | NULL | NULL | NULL |
| TMS PROVIDER NUMBER | NULL | NULL | NULL | NULL | NULL | NULL | NULL | NULL | NULL | NULL |
| TMS SSL ACTIVATED | NULL | NULL | NULL | NULL | NULL | NULL | NULL | NULL | NULL | NULL |
| TMS SSL NAME | NULL | NULL | NULL | NULL | NULL | NULL | NULL | NULL | NULL | NULL |
| TMS_X25_ADDRESS | NULL | NULL | NULL | NULL | NULL | NULL | NULL | NULL | NULL | NULL |
| TOTAL FLASH | 256 | 512 | 256 | 512 | 256 | 512 | 256 | 512 | 512 | 256 |
| TOTAL RAM | 128 | 512 | 128 | 512 | 128 | 512 | 128 | 512 | 512 | 128 |
| TOUCH SCREEN RESISTIF | NULL | 1 | NULL | 1 | NULL | 1 | NULL | 1 | 1 | NULL |
| USBD TYPE | 6 | 3 | 5 | 3 | 6 | 3 | 4 | 1 | 3 | 4 |
| USBH_TYPE | 1 | 1 | 1 | 1 | 1 | 1 | 1 | 1 | 1 | 1 |
| USB HOST | 1 | 1 | 1 | 1 | 1 | 1 | 1 | 1 | 1 | 1 |
| USB SLAVE | 1 | 1 | 1 | 1 | 1 | 1 | 1 | 1 | 1 | 1 |
| V90 | NULL | NULL | NULL | NULL | NULL | NULL | NULL | NULL | NULL | NULL |
| VID | NULL | NULL | NULL | NULL | NULL | NULL | NULL | NULL | NULL | NULL |
| VIDEO | NULL | 1 | NULL | 1 | NULL | 1 | NULL | 1 | NULL | 1 |
| VIDEO TYPE | 0 | 1 | 0 | 1 | 0 | 1 | 0 | 1 | 1 | 0 |
| WEBPLATFORM | NULL | NULL | NULL | NULL | NULL | NULL | NULL | NULL | NULL | NULL |
| WIDTH | 240 | 320 | 320 | 320 | 240 | 320 | 240 | 320 | 320 | 240 |
| WIFI | NULL | 1 | NULL | 1 | 1 | 1 | 1 | NULL | 1 | 1 |
| WIFI_MAC | NULL | 0W54E140D | NULL | 0W54E1405 [symbol] | 0W54E1405 [symbol] | 0W54E140D [symbol] | 0W54E1405 [symbol] | NULL | 0W54E1403 [symbol] | 0W54E1405 [symbol] |
| WIFI TYPE | 0 | 1 | 0 | 1 | 5 | 1 | 1 | 0 | 1 | 1 |
| authorized activities | DOWNLOAD | DOWNLOAD | DOWNLOAD | DOWNLOAD | DOWNLOAD | DOWNLOAD | DOWNLOAD | DOWNLOAD | DOWNLOAD | DOWNLOAD |
| callMedium | GPRS | ETHERNET | ETHERNET | ETHERNET | WIFI | ETHERNET | ETHERNET | UNKNOWN | UNKNOWN | ETHERNET |
| calling ApplicationId | 9992044631 | 9992044631 | 9992044631 | 9992044631 | 9992044631 | 9992044631 | 9992044631 | 9992044631 | 9992044631 | 9992044631 |
| calling ApplicationVr | V07-01.02 | V08-02.01 | V08-02.01 | V08-02.01 | V08-02.01 | V08-02.01 | V08-02.01 | V08-02.01 | V08-02.01 | V08-02.01 |
| content | NULL | NULL | NULL | NULL | NULL | NULL | NULL | NULL | NULL | NULL |
| contractNumber | 111625102 | 733069801 | 323195501 | 208739001 | 885284701 | 570663101 | 243270101 | 581290901 | 851322701 | 244204201 |
| isSSL | false | false | false | false | false | false | false | false | false | false |
| locationVersion | 16182731 | 17104223 | 16272731 | 17100733 | 17217733 | 17107223 | 16308733 | 15180731 | 16118731 | 16280733 |
| productCode | M76 | M71 | M74 | M71 | M76 | M71 | M75 | M70 | M71 | M75 |
| productNumber | 30510174 | 31910099 | 30010201 | 31910185 | 30810509 | 31910099 | 31910181 | 30010108 | 31910099 | 31910186 |
| protocolVersion | 300 | 300 | 300 | 300 | 300 | 300 | 300 | 300 | 300 | 300 |
| serialNumber | 1110076 | 7002770 | 1180735 | 1433537 | 1712360 | 7002827 | 1221850 | 1004453 | 1058895 | 1193962 |
| technology | TETRA | TETRA | TETRA | TETRA | TETRA | TETRA | TETRA | TETRA | TETRA | TETRA |

| | | | | | | |
|---|---|---|---|---|---|---|
| NETWORK PORT NUMBER | NULL | NULL | NULL | NULL | NULL | NULL |
| NETWORK PREFIX | NULL | NULL | NULL | NULL | NULL | NULL |
| NETWORK SERIAL LINK | NULL | NULL | NULL | NULL | NULL | NULL |
| NETWORK_SSL_ACTIVATED | NULL | NULL | NULL | NULL | NULL | NULL |
| NETWORK SSL NAME | NULL | NULL | NULL | NULL | NULL | NULL |
| OPTION CARD | NULL | NULL | NULL | NULL | NULL | NULL |
| OPTION CARD TYPE | 0 | NULL | NULL | 0 | 0 | 0 |
| OS COUNTER 20 | 8571669 | 47755630 | 30202757 | 7550652 | 16657032 | 8059708 |
| OS_COUNTER_21 | NULL | 1250 | 57 | 2 | 2159 | 446 |
| OS COUNTER 22 | 212996 | 7615321 | 146874 | 44781 | 265851 | 93510 |
| OS COUNTER 23 | NULL | NULL | NULL | NULL | NULL | NULL |
| OS COUNTER 24 | NULL | NULL | NULL | NULL | NULL | NULL |
| OS COUNTER 25 | NULL | NULL | NULL | NULL | NULL | NULL |
| OS_COUNTER_26 | NULL | NULL | NULL | NULL | NULL | NULL |
| OS COUNTER 27 | NULL | NULL | NULL | NULL | NULL | NULL |
| OS COUNTER 28 | NULL | NULL | NULL | NULL | NULL | NULL |
| OS COUNTER 29 | NULL | NULL | NULL | NULL | NULL | NULL |
| OS COUNTER 30 | NULL | NULL | NULL | NULL | NULL | NULL |
| OS_COUNTER_31 | NULL | NULL | NULL | NULL | NULL | NULL |
| PABX | NULL | NULL | NULL | NULL | NULL | NULL |
| PHONE HOME STATUS | NULL | NULL | NULL | NULL | NULL | NULL |
| PID | NULL | NULL | NULL | NULL | NULL | NULL |
| PINPAD ACTIVATED | NULL | NULL | NULL | NULL | NULL | NULL |
| PINPAD_CONNECTED | NULL | NULL | NULL | NULL | NULL | NULL |
| PINPAD PKI LEVEL | NULL | NULL | NULL | NULL | NULL | NULL |
| PINPAD TYPE | 1 | 1 | 1 | 1 | 1 | 1 |
| PKI | 3 | 3 | 3 | 3 | 3 | 3 |
| PLATFORM | 1 | 1 | 0 | 1 | 1 | 1 |
| POE_TYPE | NULL | NULL | NULL | NULL | NULL | NULL |
| PORTABLE | 1 | 1 | NULL | 1 | 1 | 1 |
| PRINTER | 1 | 1 | 1 | 1 | 1 | 1 |
| PRINTER TYPE | 2 | 1 | 1 | 1 | 1 | 2 |
| PRODUCT CODE | M76 | M71 | M70 | M75 | M75 | M76 |
| PRODUCT_NAME | Move2500 | Move5000 | DESK5000 | Move3500 | Move3500 | Move2500 |
| PRODUCT REFERENCE | 10130 | 10085 | 3 | 10186 | 10181 | 10509 |
| PRODUCT TYPE | 1 | 1 | 1 | 1 | 1 | 1 |
| PWR USB TYPE | NULL | NULL | NULL | NULL | NULL | NULL |
| ROAMING | NULL | NULL | NULL | NULL | NULL | NULL |
| ROTATION | 3 | NULL | NULL | NULL | NULL | 3 |
| RTC TYPE | 1 | 1 | 1 | 1 | 1 | 1 |
| SAM1 | 1 | 1 | 1 | 1 | 1 | 1 |
| SAM2 | 1 | 1 | 1 | 1 | 1 | 1 |
| SAM3 | NULL | NULL | NULL | NULL | NULL | 1 |
| SCHEME_TYPE | 1 | 1 | 1 | 1 | 1 | 1 |
| SDCARD | NULL | 1 | NULL | 1 | 1 | NULL |
| SENSOR ACCEL | NULL | 1 | NULL | NULL | NULL | NULL |
| SERIAL | 1.72E+23 | 1.50E+23 | 1.52E+23 | 1.63E+23 | 1.63E+23 | 1.72E+23 |
| SERIAL ISLERO | 39554e4201 [symbol] | 344d533202 [symbol] | 3432503606 [symbol] | 344d533208 [symbol] | 3.34E+15 | 355546430d1 [symbol] |
| SMC_TYPE | 2 | 1 | 1 | 2 | 2 | 2 |
| SRED | NULL | NULL | NULL | NULL | NULL | NULL |
| STRING USB | NULL | NULL | NULL | NULL | NULL | NULL |
| SUB PLATFORM | 65 | 64 | 2 | 64 | 64 | 65 |
| SUPPORTED CURRENCIES | NULL | NULL | NULL | NULL | NULL | NULL |
| SWIPE_ACTIVATED | NULL | NULL | NULL | NULL | NULL | NULL |
| SWP TYPE | 1 | 1 | 1 | 1 | 1 | 1 |
| SYS CH TYPE | 2 | 2 | 2 | 2 | 2 | 2 |
| TCH TYPE | 0 | 4 | 1 | 0 | 0 | 0 |
| TEL [symbol] UM SDK | NULL | NULL | NULL | NULL | NULL | NULL |
| TERMINAL_DATE | NULL | NULL | NULL | NULL | NULL | NULL |
| TERMINAL NUMBER | NULL | NULL | NULL | NULL | NULL | NULL |
| TERMINAL PCI PTS | NULL | NULL | NULL | NULL | NULL | NULL |
| TERMINAL PCI PTS M1 | NULL | NULL | NULL | NULL | NULL | NULL |
| TERMINAL PCI PTS M3 | NULL | NULL | NULL | NULL | NULL | NULL |
| TERMINAL_PCI_PTS_M4 | NULL | NULL | NULL | NULL | NULL | NULL |
| TERMINAL PKI LEVEL | NULL | NULL | NULL | NULL | NULL | NULL |
| TERMINAL TIME | NULL | NULL | NULL | NULL | NULL | NULL |
| TMS ACCESS TYPE | NULL | NULL | NULL | NULL | NULL | NULL |
| TMS APN | NULL | NULL | NULL | NULL | NULL | NULL |
| TMS_CALL_NUMBER | NULL | NULL | NULL | NULL | NULL | NULL |
| TMS IDENTIFIER | NULL | NULL | NULL | NULL | NULL | NULL |
| TMS IP ADDRESS | NULL | NULL | NULL | NULL | NULL | NULL |
| TMS LOGIN | NULL | NULL | NULL | NULL | NULL | NULL |
| TMS PASSWORD | NULL | NULL | NULL | NULL | NULL | NULL |
| TMS_PORT_NUMBER | NULL | NULL | NULL | NULL | NULL | NULL |
| TMS PROTECTION ACTIVATED | NULL | NULL | NULL | NULL | NULL | NULL |
| TMS PROVIDER NUMBER | NULL | NULL | NULL | NULL | NULL | NULL |
| TMS SSL ACTIVATED | NULL | NULL | NULL | NULL | NULL | NULL |
| TMS SSL NAME | NULL | NULL | NULL | NULL | NULL | NULL |
| TMS_X25_ADDRESS | NULL | NULL | NULL | NULL | NULL | NULL |
| TOTAL FLASH | 512 | 512 | 512 | 256 | 256 | 256 |
| TOTAL RAM | 128 | 512 | 512 | 128 | 128 | 128 |
| TOUCH SCREEN RESISTIF | NULL | 1 | 1 | NULL | NULL | NULL |
| USBD TYPE | 6 | 3 | 1 | 4 | 4 | 6 |
| USBH_TYPE | 1 | 1 | 1 | 1 | 1 | 1 |
| USB HOST | 1 | 1 | 1 | 1 | 1 | 1 |
| USB SLAVE | 1 | 1 | 1 | 1 | 1 | 1 |
| V90 | NULL | NULL | NULL | NULL | NULL | NULL |
| VID | NULL | NULL | NULL | NULL | NULL | NULL |
| VIDEO | 1 | NULL | NULL | 1 | 1 | NULL |
| VIDEO TYPE | 0 | 1 | 1 | 0 | 0 | 0 |
| WEBPLATFORM | NULL | NULL | NULL | NULL | NULL | NULL |
| WIDTH | 240 | 320 | 320 | 240 | 240 | 240 |
| WIFI | NULL | NULL | NULL | 1 | 1 | 1 |
| WIFI_MAC | NULL | NULL | NULL | 0W54E1405 [symbol] | 0W54E1405 [symbol] | 0W54E1405 [symbol] |
| WIFI TYPE | 0 | 0 | 0 | 1 | 1 | 5 |
| authorized activities | DOWNLOAD | DOWNLOAD | DOWNLOAD | DOWNLOAD | DOWNLOAD | DOWNLOAD |
| callMedium | GPRS | GPRS | ETHERNET | ETHERNET | GPRS | WIFI |
| calling ApplicationId | 9992044631 | 9992044631 | 9992044631 | 9992044631 | 9992044631 | 9992044631 |
| calling ApplicationVr | V08-02.01 | V08-02.01 | V08-02.01 | V08-02.01 | V08-02.01 | V08-02.01 |
| content | NULL | NULL | NULL | NULL | NULL | NULL |
| contractNumber | 528426001 | 733567601 | 383256801 | 375082901 | 94686102 | 207227201 |
| isSSL | false | false | false | false | false | false |
| locationVersion | 17179733 | 15041731 | 15174732 | 16280733 | 16308733 | 17217733 |
| productCode | M76 | M71 | M70 | M75 | M75 | M76 |
| productNumber | 32210130 | 30510085 | 30000003 | 31910186 | 31910181 | 30810509 |
| protocolVersion | 300 | 300 | 300 | 300 | 300 | 300 |
| serialNumber | 1618197 | 1001994 | 1004414 | 1193991 | 1221955 | 1712486 |
| technology | TETRA | TETRA | TETRA | TETRA | TETRA | TETRA |

[symbol]

indicates data missing or illegible when filed

The data types of the terminals are written in the first left-hand column. A data type is therefore the name of a variable, whereas a data item is the value of this variable, in the other columns. This extract only contains some of the data types, there being more actual data types to be processed by the filtering sub-module 21. The data corresponding to each of these types, obtained from the terminal 5, therefore relating to the state of the terminal 5, are the data shown in the second left-hand column. The other columns contain data relating to the states of other terminals. In fact, the filtering sub-module 21 receives data from a large number of different payment terminals.

These data relate, in particular, to a counter of keys pressed on the terminal, a number of times the terminal operating system has been reloaded (“OS COUNTER” data type in the extract), a number of times the terminal 5 has been restarted, a version number of the terminal software (“protocolVersion” line), an Internet connection type of the terminal (“Wifi” line), an Internet connection state of the terminal, a connection type of the terminal (“USBD type line), a connection state of the terminal, a manufacturer code of the terminal (“productCode” line), a type of computer hardware integrated in the terminal (“TECHNOLOGY” line). Generally, all the data relating to states, either static or dynamic, of a payment terminal are likely to be sent to the filtering sub-module 21.

In step 130, the filtering sub-module 21 filters these data by data type. Thus, it only retains some data types of the left-hand column. This table of filtered data is shown below.

TABLE 2

| | | | | | | | | | | | | | | | | |
|---|---|---|---|---|---|---|---|---|---|---|---|---|---|---|---|---|
| LIFE_FLASH_BLOCK | 0 | 0 | 0 | 0 | 0 | 0 | 0 | 3 | 1 | 0 | 0 | 0 | 1 | 0 | 0 | 0 |
| REFRESH | | | | | | | | | | | | | | | | |
| LIFE FLASH GARBAGE | 6 | 6 | 10 | 4 | 7 | 15 | 10 | 15 | 28 | 9 | 6 | 19 | 30 | 6 | 7 | 6 |
| LIFE_KEY_PRESSED | 5259 | 42317 | 60312 | 940 | 3592 | 2323 | 30680 | 124167 | 61179 | 53253 | 40006 | 16388 | 4862 | 1904 | 49323 | 55828 |
| LIFE LOWPOWER | 1251 | 673 | 0 | 101 | 2365 | 4629 | 1702 | 0 | 7282 | 3836 | 15455 | 209 | 0 | 302 | 4139 | 14925 |
| NUMBER | | | | | | | | | | | | | | | | |
| LIFE_POWER_FIQ_ | 3 | 4622 | 0 | 51 | 0 | 1109 | 6173 | 0 | 23238 | 34404 | 0 | 1465 | 0 | 424 | 17899 | 0 |
| FILTERED | | | | | | | | | | | | | | | | |
| LIFE_POWER_ | 37 | 12 | 9 | 3 | 20 | 27 | 10 | 19 | 51 | 21 | 7 | 29 | 8 | 8 | 18 | 17 |
| SHUTDOWN | | | | | | | | | | | | | | | | |
| LIFE PRINTER DOTS | 41049064 | 93952593 | 388330216 | 5217293 | 30474746 | 15627582 | 201953882 | 1054542516 | 426016889 | 516520784 | 309754148 | 251476134 | 50279008 | 16040046 | 465915271 | 408249048 |
| NUMBER | | | | | | | | | | | | | | | | |
| LIFE_PRINTER_STEP_ | 1490060 | 3694986 | 14819889 | 204402 | 1199077 | 603751 | 8013039 | 36534694 | 15328243 | 20088507 | 10160417 | 8958588 | 1953455 | 634595 | 16681023 | 14874100 |
| NUMBER | | | | | | | | | | | | | | | | |
| LIFE PRINTING TIME | 217738 | 300080 | 1636326 | 17932 | 164596 | 53594 | 690819 | 3744072 | 1431786 | 1999874 | 1336354 | 722506 | 223335 | 54487 | 1517599 | 1880078 |
| LIFE_RESET | 281 | 320 | 522 | 33 | 222 | 272 | 398 | 746 | 835- | 632 | 269 | 784 | 508 | 151 | 398 | 246 |
| LIFE_RESET_BY_ | 243 | 307 | 512 | 29 | 200 | 244 | 386 | 726 | 783 | 610 | 260 | 754 | 499 | 142 | 379 | 228 |
| SOFTWARE | | | | | | | | | | | | | | | | |
| LIFE SWIPE 1 | 6 | 6 | 1 | 0 | 0 | 6 | 2 | 4 | 31 | 602 | 0 | 95 | 0 | 10 | 80 | 3 |
| LIFE_SWIPE_2 | 6 | 37 | 12 | 0 | 1 | 6 | 2 | 5 | 89 | 1344 | 0 | 441 | 6 | 10 | 921 | 3 |
| LIFE SWIPE 2 IS ISO2 OK | 0 | 3 | 0 | 0 | 0 | 6 | 2 | 2 | 1 | 0 | 0 | 0 | 0 | 0 | 0 | 2 |
| LIFE_SWIPE 3 | 6 | 3 | 0 | 0 | 0 | 6 | 5 | 3 | 58 | 1098 | 0 | 771 | 0 | 9 | 944 | 2 |
| LIFE_TIME_RUNNING | 10609330 | 17434866 | 31438162 | 697319 | 3342804 | 5813831 | 20620534 | 48099475 | 37226332 | 35166082 | 8607503 | 47756592 | 30202757 | 7551310 | 16662127 | 8073851 |
| LIFE USB CHARGER | 23 | 8 | 0 | 30 | 13 | 35 | 6 | 0 | 78 | 21 | 13 | 29 | 0 | 5 | 12 | 8 |
| CONNECTION | | | | | | | | | | | | | | | | |
| MOBILE_NETWORK_ | NULL | NULL | NULL | NULL | NULL | NULL | NULL | NULL | NULL | NULL | NULL | NULL | NULL | NULL | NULL | NULL |
| OPERATOR | | | | | | | | | | | | | | | | |
| MOBILE SIGNAL | NULL | NULL | NULL | NULL | NULL | NULL | NULL | NULL | NULL | NULL | NULL | NULL | NULL | NULL | NULL | NULL |
| STRENGTH | | | | | | | | | | | | | | | | |
| MODEM | NULL | NULL | 1 | NULL | NULL | NULL | NULL | 1 | NULL | NULL | 1 | NULL | 1 | NULL | NULL | NULL |
| MODEM_TYPE | 0 | 0 | 1 | 0 | 0 | 0 | 0 | 1 | 0 | 0 | 2 | 0 | 1 | 0 | 0 | 0 |
| NETWORK ACCESS | NULL | NULL | NULL | NULL | NULL | NULL | NULL | NULL | NULL | NULL | NULL | NULL | NULL | NULL | NULL | NULL |
| NETWORK_APN | NULL | NULL | NULL | NULL | NULL | NULL | NULL | NULL | NULL | NULL | NULL | NULL | NULL | NULL | NULL | NULL |
| NETWORK COMMAND | NULL | NULL | NULL | NULL | NULL | NULL | NULL | NULL | NULL | NULL | NULL | NULL | NULL | NULL | NULL | NULL |
| MODE | | | | | | | | | | | | | | | | |
| NETWORK FORCE_ | NULL | NULL | NULL | NULL | NULL | NULL | NULL | NULL | NULL | NULL | NULL | NULL | NULL | NULL | NULL | NULL |
| PREFIX | | | | | | | | | | | | | | | | |
| NETWORK_FORCE_PSTN | NULL | NULL | NULL | NULL | NULL | NULL | NULL | NULL | NULL | NULL | NULL | NULL | NULL | NULL | NULL | NULL |
| NETWORK FORCE V32 | NULL | NULL | NULL | NULL | NULL | NULL | NULL | NULL | NULL | NULL | NULL | NULL | NULL | NULL | NULL | NULL |
| NETWORK_GATEWAY | NULL | NULL | NULL | NULL | NULL | NULL | NULL | NULL | NULL | NULL | NULL | NULL | NULL | NULL | NULL | NULL |
| NETWORK GATEWAY | NULL | NULL | NULL | NULL | NULL | NULL | NULL | NULL | NULL | NULL | NULL | NULL | NULL | NULL | NULL | NULL |
| ACCESS | | | | | | | | | | | | | | | | |
| NETWORK_GSM_GPRS_ | NULL | NULL | NULL | NULL | NULL | NULL | NULL | NULL | NULL | NULL | NULL | NULL | NULL | NULL | NULL | NULL |
| START_MODE | | | | | | | | | | | | | | | | |
| NETWORK_IP_ADDRESS | NULL | NULL | NULL | NULL | NULL | NULL | NULL | NULL | NULL | NULL | NULL | NULL | NULL | NULL | NULL | NULL |
| NETWORK LOGIN | NULL | NULL | NULL | NULL | NULL | NULL | NULL | NULL | NULL | NULL | NULL | NULL | NULL | NULL | NULL | NULL |
| NETWORK_PAD_ | NULL | NULL | NULL | NULL | NULL | NULL | NULL | NULL | NULL | NULL | NULL | NULL | NULL | NULL | NULL | NULL |
| FORCE_V32 | | | | | | | | | | | | | | | | |
| NETWORK PASSWORD | NULL | NULL | NULL | NULL | NULL | NULL | NULL | NULL | NULL | NULL | NULL | NULL | NULL | NULL | NULL | NULL |
| NETWORK_PORT_ | NULL | NULL | NULL | NULL | NULL | NULL | NULL | NULL | NULL | NULL | NULL | NULL | NULL | NULL | NULL | NULL |
| NUMBER | | | | | | | | | | | | | | | | |
| NETWORK_PREFIX | NULL | NULL | NULL | NULL | NULL | NULL | NULL | NULL | NULL | NULL | NULL | NULL | NULL | NULL | NULL | NULL |
| NETWORK SERIAL LINK | NULL | NULL | NULL | NULL | NULL | NULL | NULL | NULL | NULL | NULL | NULL | NULL | NULL | NULL | NULL | NULL |
| NETWORK_SSL_ | NULL | NULL | NULL | NULL | NULL | NULL | NULL | NULL | NULL | NULL | NULL | NULL | NULL | NULL | NULL | NULL |
| ACTIVATED | | | | | | | | | | | | | | | | |
| NETWORK SSL NAME | NULL | NULL | NULL | NULL | NULL | NULL | NULL | NULL | NULL | NULL | NULL | NULL | NULL | NULL | NULL | NULL |
| OPTION_CARD | NULL | NULL | NULL | NULL | NULL | NULL | NULL | NULL | NULL | NULL | NULL | NULL | NULL | NULL | NULL | NULL |
| OPTION_CARD_TYPE | 0 | NULL | 0 | 0 | 0 | NULL | 0 | NULL | NULL | 0 | 0 | NULL | NULL | 0 | 0 | 0 |
| OS COUNTER 20 | 10607949 | 17413202 | 31438162 | 697134 | 3340348 | 5809118 | 20616968 | 48098275 | 37219672 | 35161389 | 8571669 | 47755630 | 30202757 | 7550652 | 16657032 | 8059708 |
| OS_COUNTER_21 | NULL | NULL | NULL | NULL | 12 | 1 | NULL | 510 | 359 | 4391 | NULL | 1250 | 57 | 2 | 2159 | 446 |
| OS COUNTER 22 | 235321 | 338219 | 149013 | 4863 | 53383 | 129851 | 217776 | 356111 | 672721 | 203062 | 212996 | 7615321 | 146874 | 44781 | 265851 | 93510 |
| OS_COUNTER_23 | NULL | NULL | NULL | NULL | NULL | NULL | NULL | NULL | NULL | NULL | NULL | NULL | NULL | NULL | NULL | NULL |
| OS_COUNTER_24 | NULL | NULL | NULL | NULL | NULL | NULL | NULL | NULL | NULL | NULL | NULL | NULL | NULL | NULL | NULL | NULL |
| OS COUNTER 25 | NULL | NULL | NULL | NULL | NULL | NULL | NULL | NULL | NULL | NULL | NULL | NULL | NULL | NULL | NULL | NULL |
| OS_COUNTER_26 | NULL | NULL | NULL | NULL | NULL | NULL | NULL | NULL | NULL | NULL | NULL | NULL | NULL | NULL | NULL | NULL |
| OS COUNTER 27 | NULL | NULL | NULL | NULL | NULL | NULL | NULL | NULL | NULL | NULL | NULL | NULL | NULL | NULL | NULL | NULL |
| OS_COUNTER 28 | NULL | NULL | NULL | NULL | NULL | NULL | NULL | NULL | NULL | NULL | NULL | NULL | NULL | NULL | NULL | NULL |
| OS_COUNTER_29 | NULL | NULL | NULL | NULL | NULL | NULL | NULL | NULL | NULL | NULL | NULL | NULL | NULL | NULL | NULL | NULL |
| OS COUNTER 30 | NULL | NULL | NULL | NULL | NULL | NULL | NULL | NULL | NULL | NULL | NULL | NULL | NULL | NULL | NULL | NULL |
| OS_COUNTER_31 | NULL | NULL | NULL | NULL | NULL | NULL | NULL | NULL | NULL | NULL | NULL | NULL | NULL | NULL | NULL | NULL |
| PABX | NULL | NULL | NULL | NULL | NULL | NULL | NULL | NULL | NULL | NULL | NULL | NULL | NULL | NULL | NULL | NULL |
| PHONE_HOME_STATUS | NULL | NULL | NULL | NULL | NULL | NULL | NULL | NULL | NULL | NULL | NULL | NULL | NULL | NULL | NULL | NULL |
| PD | NULL | NULL | NULL | NULL | NULL | NULL | NULL | NULL | NULL | NULL | NULL | NULL | NULL | NULL | NULL | NULL |
| PINPAD ACTIVATED | NULL | NULL | NULL | NULL | NULL | NULL | NULL | NULL | NULL | NULL | NULL | NULL | NULL | NULL | NULL | NULL |
| PINPAD_CONNECTED | NULL | NULL | NULL | NULL | NULL | NULL | NULL | NULL | NULL | NULL | NULL | NULL | NULL | NULL | NULL | NULL |
| PINPAD PKI LEVEL | NULL | NULL | NULL | NULL | NULL | NULL | NULL | NULL | NULL | NULL | NULL | NULL | NULL | NULL | NULL | NULL |

All the data in this table were included in the data initially received (not all were shown in the extract), but only the data in this second table are sent by this filtering sub-module 21 to the optimisation sub-module 22. Once again, the second left-hand column shows the data obtained from the terminal 5. The data types to be filtered, which are identified during this method, will be described below.

In step 140, the optimisation sub-module 22 implements a negative-selection artificial immune algorithm on the filtered data of the terminal 5 received from the filtering sub-module 21. The purpose of this algorithm is to identify whether this data set corresponds to a real or future fault, or malfunction, profile of the terminal 5, this identification being made by fault profile detectors generated beforehand by learning. If none of the detectors used by this fault profile algorithm identifies a fault profile, this means that there is no need to make a correction on the terminal 5, and the method moves directly to step 160. However, if a fault profile detector resulting from this algorithm identifies the data set as corresponding to a real or future fault, then this data set is transmitted to the optimisation sub-module 23. In the remainder of the document, we will consider that the latter case applies.

The way in which the fault detectors are generated will be described below.

In step 145, this optimisation sub-module 22 sends to the filtering sub-module 21, via the return loop 24, data types to be filtered which were identified during this step of negative selection. They are the names of the variables used which identified that the terminal 5 had a fault profile.

Alternatively, the sub-module could send the other data types, for example the names of the variables which proved unnecessary.

In step 150, the decision sub-module 23 implements a random forest algorithm on the data set of the terminal 5 transmitted by the optimisation sub-module 22. This algorithm is used to identify which component(s) of the terminal 5 are responsible for the fault identified by the optimisation sub-module 22. The component(s) is/are identified by the prior learning of this random forest algorithm on a learning database.

At the end of this so-called decision-making step, the characteristics considered as being faulty or at risk of being faulty, relating to the components of the terminal 5, have been identified. An alert can therefore be raised to correct these characteristics in order to prevent a failure or the worsening of a simple failure of the terminal 5.

In step 155, this decision sub-module 23 returns data types to be filtered to the filtering module 21. They correspond to the names of the variables that were used to characterise one or more components of the terminal as being faulty or at risk of being faulty. Alternatively, they may correspond to the names of the other variables, those which proved to be unnecessary.

We will now describe the self-regulation loop formed by the returns or return loops 24 and 25 from the respective sub-modules 22 and 23, up to the filtering module 21.

In fact, on each iteration of the method 100, for the terminal 5 as well as for the other terminals, data types to be filtered are sent in steps 145 and 155 to the filtering sub-module 21. These data types are stored by the sub-module 21 ready for use in the next iteration of the method. It can be decided that only the data types that have been returned most frequently, and not all of them, will be considered as being data types to be “filtered” by this sub-module 21. Alternatively, it may be the types returned a certain number of times in proportion to others, or having reached a predetermined number of corresponding returned data.

With this self-regulation loop, the computing means 11 improve the method 100 on each iteration. In fact, the data to be filtered become increasingly relevant and less numerous, which makes the next steps faster and precise.

We will now describe a method 200 for maintenance of the terminal 5, referring to FIG. 4.

The step 210 of this method corresponds to the steps 110 to 155 of the method 100 for identifying a malfunction of the terminal 5. Thus, at the end of step 210, one or more characteristics of the terminal 5 are identified as malfunctioning.

In step 220, the decision of the random forest algorithm, which corresponds to one or more characteristics of the terminal being faulty or at risk of being faulty, is sent to the scheduling module 3. This module automatically deduces a correction to be made on the terminal 5, and sends this chosen characteristic to the scheduling module 4. The correction to be chosen has been configured, manually beforehand, according to the fault characteristics identified. Alternatively, computing means have been trained, by learning on a learning database, to deduce a suitable correction according to the one or more faults identified.

In step 230, the scheduling module 4 performs remotely the correction to be made on the terminal 5.

We will now describe a method 300 for initialising the module 2 before its implementation in the server 1, referring to FIG. 5.

Before implementing the method 100 and therefore before the first implementation of the self-regulation loop, the filtering sub-module 21 does not include any data type to be filtered.

Consequently, in step 70, the sub-module 21, in relation with the means 11, is trained to identify the data types to be filtered ready for step 130 of the method 100 for detecting the risk of malfunction. To do this, the means 11 use a learning database, so that the means 11 identify therein the data types to be filtered. These types correspond to data considered to be useful for the next steps of the method. In particular, they are the names of the variables, in the first left-hand column of the tables shown above, having an impact on the detection, in the immune algorithm, of a risk of malfunction, or on the decision chosen in the random forest algorithm. In other words, these data types to be filtered are the data types useful for subsequent determinations to be made by the autonomous module. Once these data types to be filtered have been identified, they are implemented in the filtering sub-module 21 before the first iteration of the method 100 for detecting the risk of malfunction on real data, including those of the terminal 5. Thus, using this step 70, during the first iteration of the method 100, the filtering sub-module 21 already includes data types to be filtered in step 130.

In step 80, the negative-selection artificial immune algorithm is trained on a learning database, so that it forms one or more fault profile detectors. The Jaro-Winkler distance is chosen in this algorithm to define the affinity thresholds of the fault profile detectors. Alternatively, a Euclidean distance could be chosen. The purpose of these fault profile detectors is to identify data sets, each set corresponding to a terminal, which correspond to one or more real or future malfunctions of the terminal. Once the fault profiles have been generated by the learning, they are implemented in the optimisation sub-module 22 before the first iteration of the method 100 for detecting the risk of malfunction on real data, including those of the terminal 5. These profile detectors will then detect the faults of the terminals.

In step 90, the random forest algorithm is trained on a learning database. This algorithm is thus trained to identify, using a data set corresponding to a real or future fault of the terminal, the one or more faulty characteristics of the terminal.

These learning, or initiation, steps 70 to 90, can be implemented separately, on separate learning databases, or jointly on the same learning database. After performing these steps, the method 100 can be implemented using the data types to be filtered identified in step 70, the fault profile detectors generated in step 80, and the decision trees generated in step 90.

The invention is not limited to the embodiments described and other embodiments will be clearly apparent to those skilled in the art.

1. A method for detecting a risk of malfunction of a computer peripheral device, wherein computing means perform steps of:
obtaining data relating to a current state of the computer peripheral device;
filtering the obtained data in such a way as to retain only some of the obtained data, the retained data forming filtered data;
applying a negative-selection artificial immune algorithm to the filtered data so as to distinguish data forming a fault profile from data forming a normal operating profile; and
applying a random forest algorithm to the data forming the fault profile so as to detect one or more components at risk of malfunction within the computer peripheral device.

2. The method according to claim 1, wherein the computing means-perform the steps of:
identifying, during the step of applying the immune algorithm, data types to distinguish between the fault profile and the normal operating profile;
identifying, during the step of applying the random forest algorithm, data types allowing the detection of one or more faulty characteristics;
the data types identified during the two identification steps forming data types to be filtered, integrating in the filtering step data types to be filtered, so that, when reiterating the method, the filtering step is performed based on the data types to be filtered.

3. The method according to claim 2, wherein, beforehand, since the data types to be filtered do not exist, the computing means perform, on a learning database, a step of training relating to the filtering, in order to identify first data types to be filtered.

4. The method according to claim 1, wherein, beforehand, the computing means perform, on a learning database, a step of training the negative-selection artificial immune algorithm, in order to form computer peripheral device fault profile detectors.

5. The method according to claim 4, wherein an affinity distance relating to the fault profile detectors is a Jaro-Winkler distance.

6. The method according to claim 1, wherein, beforehand, the computing means perform, on a learning database, a step of training the random forest algorithm, in order to learn how to detect faulty characteristics of computer peripheral devices.

7. The method according to claim 1, wherein the peripheral device is a payment terminal.

8. The method according to claim 7, wherein the obtained data of the payment terminal-relate to:
a counter of keys pressed on the terminal;
a number of times a terminal operating system has been reloaded;
a number of times the terminal has been restarted;
a version number of terminal software;
an Internet connection type of the terminal;
an Internet connection state of the terminal;
a connection type of the terminal;
a connection state of the terminal;
a manufacturer code of the terminal;
a type of computer hardware integrated in the terminal.

9. A maintenance method for a computer peripheral device, wherein computing means perform steps of:
implementing the method for detecting the risk of malfunction of a computer peripheral device, according to claim 1;
depending on the malfunction detected, identifying a correction to be made to a software configuration of the peripheral device.

10. The method according to claim 9, wherein the computing means further perform a step of automatically correcting the peripheral device by applying the identified correction to the peripheral device.

11. A maintenance server comprising computing means adapted to perform the steps of a method-according to claim 1.

12. A payment system comprising a maintenance server according to claim 11 and at least one payment terminal, the payment terminal being adapted to transmit, to the server, data relating to a current state of the terminal.

13. A computer program, comprising instructions which, when the program is executed by a computer, instruct the computer to implement the steps of the method according to claim 1.

14. A computer-readable storage medium, comprising instructions which, when they are executed by a computer, instruct the computer to implement the steps of a method according to claim 1.
